(19) United States
(12) Patent Application Publication
(10) Pub. No.: US 2024/0112435 A1
(43) Pub. Date: Apr. 4, 2024

(54) IMAGE RECORDING DEVICE

(71) Applicant: ABILITY ENTERPRISE CO., LTD., New Taipei City (TW)

(72) Inventor: Chun-Hsiung CHAO, New Taipei City (TW)

(21) Appl. No.: 18/243,100

(22) Filed: Sep. 7, 2023

(30) Foreign Application Priority Data
Sep. 29, 2022 (TW) 111136978

(51) Int. Cl. G06V 10/10; G06T 7/13; G06V 10/141; G06V 10/25

(52) U.S. Cl. CPC G06V 10/16; G06T 7/13; G06V 10/141; G06V 10/25; G06T 2207/30256

(57) ABSTRACT

An image recording device and an image processing method are provided. The image recording device includes a first image capturing module, a processor and a storage module. The first image capturing module includes a first lens and a first sensor catching a light beam passing through the first lens and providing a first image; the processor receives the first image, selects a first partial area of the first image, copies image data of the first partial area and provides a first partial image, and performs image process on the first image and generates a first adjusted image; and the storage module stores the first image, the first partial image and the first adjusted image.

This application claims the benefit of Taiwan application Serial No. 111136978, filed Sep. 29, 2022, the subject matter of which is incorporated herein by reference.

### TECHNICAL FIELD

The present invention relates in general to an image recording device and an image processing method.

### BACKGROUND

Nowadays, the market demand for recording traffic information is not only limited to continuous recording of dynamic images as reference for future traffic accidents, but also users would like to quickly find out the cause of the accident or the license plate number of the vehicle involved in the accident rather than spending longer time to check the recorded data. On the other hand, in consideration of the fact that long-time recording requires a large memory card capacity, the existing vehicle recording devices adopt a relatively poor resolution recording mechanism, which causes drivers to have difficulties in accurately recognizing the license plate number of the vehicle involved in the accident after finding out the license plate number of the vehicle involved in the incident in the video. Therefore, it is necessary to propose a recording device and an image processing method for recording traffic information which can be quickly accessed, with high image resolution and reliable information.

### SUMMARY

One embodiment of the present invention provides an image recording device including a first image capturing module, a processor and a storage module. The first image capturing module includes a first lens and a first sensor catching a light beam passing through the first lens and providing a first image; the processor selects a first partial area of the first image, copies image data of the first partial area and provides a first partial image, and adjusts the first image and generates a first adjusted image; and the storage module stores the first image, the first partial image and the first adjusted image.

One embodiments of the present invention further provides an image recording device including a first image capturing module, a second image capturing module and a processor. The first image capturing module catches light beam and provides a first image; the second image capturing module catches light beam and provides a second image; and the processor generates a first partial image with the first image and/or generates a second partial image with the second image, and stitches the first image and the second image to generate an integrated image.

Another embodiment of the present invention provides an image processing method includes: capturing a first image by a first image capturing module; and selecting, by a processor, a first partial area of the first image, copying image data of the first partial area and generating a first partial image, and adjusting a first image and generating a first adjusted image.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram of an image recording device according to one embodiment of the present invention.

FIG. 2 is a flowchart of a method for preliminary processing of a first image according to one embodiment of the present invention.

FIG. 3 is a schematic diagram illustrating capturing a first partial image of a first partial area according to one embodiment of the present invention.

FIG. 4 is a schematic diagram of a first adjusted image, a second image and a first partial image according to one embodiment of the present invention.

FIG. 5 is a block diagram of an image recording device according to another embodiment of the present invention.

FIG. 6A is a schematic diagram of a first image according to one embodiment of the present invention.

FIG. 6B is a schematic diagram showing a field of view photographed in a horizontal direction according to one embodiment of the present invention.

FIG. 6C is a schematic diagram showing a field of view photographed in a vertical direction according to one embodiment of the present invention.

FIG. 7A is a schematic diagram of a first image according to another embodiment of the present invention.

FIG. 7B is a schematic diagram showing a field of view photographed in a horizontal direction according to another embodiment of the present invention.

FIG. 7C is a schematic diagram showing a field of view photographed in a vertical direction according to another embodiment of the present invention.

FIG. 8A is a schematic diagram of a first image according to still another embodiment of the present invention.

FIG. 8B is a schematic diagram of a first image according to still another embodiment of the present invention.

FIG. 8C is a schematic diagram of a first image according to further embodiment of the present invention.

### DETAILED DESCRIPTION

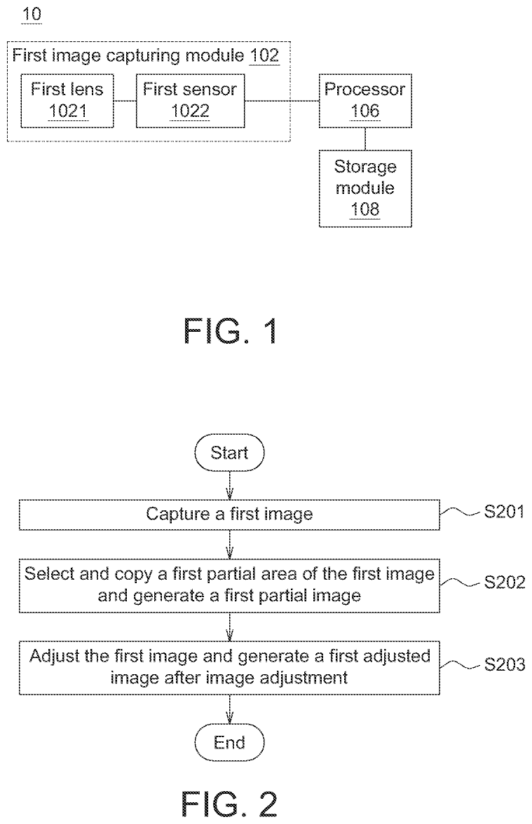

FIG. 1 is a block diagram of an image recording device 10 according to one embodiment of the present invention. As shown in FIG. 1, the image recording device 10 at least includes a first image capturing module 102, a processor 106, and a storage module 108. The first image capturing module 102 includes a first lens 1021 and a first sensor 1022. The processor 106 is electrically connected to the first image capturing module 102 and the storage module 108. In one specific embodiment, the image recording device 10 may be a vehicle recorder, which may be mounted on a motor vehicle, including but not limited to a car, truck, bus, motorcycle, etc. The first sensor 1022 may be a photoelectric conversion element, including but not limited to a Charge Coupled Device (CCD) sensor or a Complementary Metal-Oxide Semiconductor (CMOS) sensor, CMOS photo transistor. The processor 106 may be an image processing chip. The processor 106 may be an image processing chip. The storage module 108 may be non-transitory memory, such as flash memory.

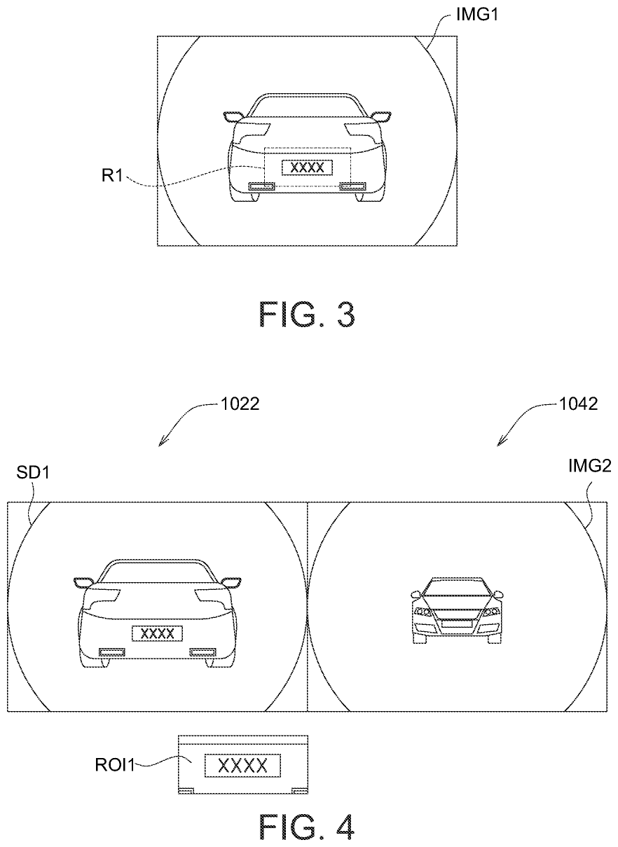

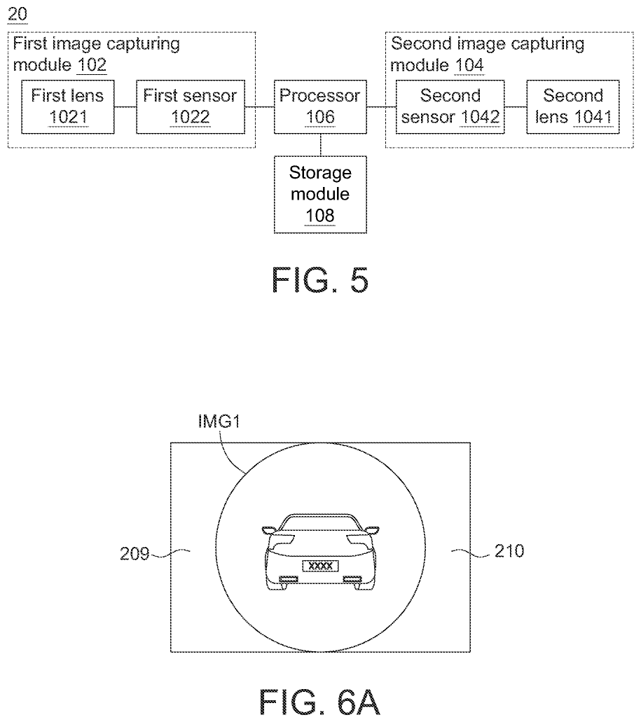

FIG. 2 is a flowchart of a method for preliminary processing of a first image IMG1 according to one embodiment of the present invention. FIG. 3 is a schematic diagram illustrating capturing a first partial image ROI1 of a first partial area R1 according to one embodiment of the present invention.

Referring to FIGS. 1-3, as shown in step S201, the first image capturing module 102 captures images in a first direction, and the first sensor 1022 may catch a light beam passing through the first lens 1021 and generate a first image IMG1, which may be received by the processor 106. As shown in step S202, the processor 106 may select a first partial area R1 of the first image IMG1, and copy the image data of the partial area R1 to form a first partial image ROI1. On the other hand, as shown in Step S203, the processor 106 may further perform image adjustment on the first image IMG1 and generate a first adjusted image SD1 after image adjustment.

Next, the image recording device 10 may store the first image IMG1, the first partial image ROI1, and the first adjusted image SD1 in accordance with the storage module 108. The image adjustment is performed to generate the first adjusted image SD1 by reducing pixels, including but not limited to scaling down, compressing, and cropping the image, so that the pixels of the first adjusted image SD1 are less than the pixels of the first image IMG1.

In one embodiment, the processor 106 may further perform preliminary image processing on the first image IMG1 before selecting the first partial area R1 of the first image IMG1. The preliminary image processing includes, but is not limited to, removing the black edges of the image, improving the distorted area of the image, resolving the color deviation of the image, and trimming the deformation of the image edges. In one specific embodiment, the image adjustment procedure is performed after the preliminary image processing is completed.

In one embodiment, the first image IMG1 may have m₁×n₁ pixels, the first partial image ROI1 may have m₀×n₀ pixels, and the first adjusted image SD1 after image adjustment may have a₁m₁×b₁n₁ pixels. Herein, m₁, a₁m₁, and m₀ are the number of columns arranged in the vertical direction of the first image IMG1, the first adjusted image SD1 and the first partial image ROI1, respectively, which may represent the length of the image; n₁, b₁n₁, and n₀ are the number of rows arranged in the horizontal direction of the first image IMG1, the first adjusted image SD1 and the first partial image ROI1, respectively, which may represent the width of the image, and m₁, n₁, m₀, and n₀ are all positive integers, a₁ and b₁ are all positive numbers less than 1, and a₁m₁ and b₁n₁ are all positive integers.

In one specific embodiment, m₁ may be x times n₁, m₀ may be y times n₀, and x and y are positive numbers, for example, x and y are between 1.7 and 2.3, respectively; in another specific embodiment, a₁ and b₁ may be between 0.4 and 0.6, respectively; and in still another specific embodiment, m₁×n₁=3840×1920, m₀×n₀=1920×1080, a₁m₁×b₁n₁=1920×960, but the present invention is not limited thereto.

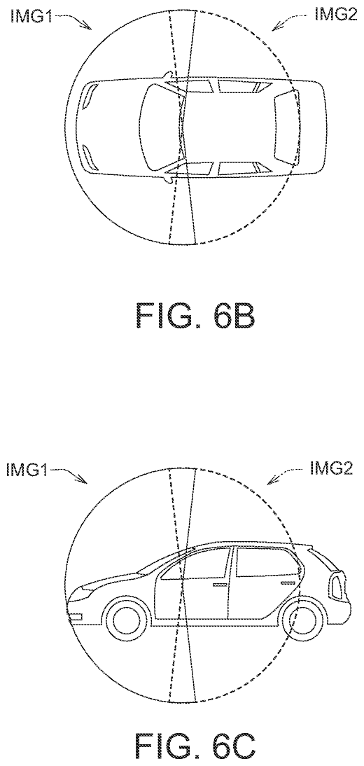

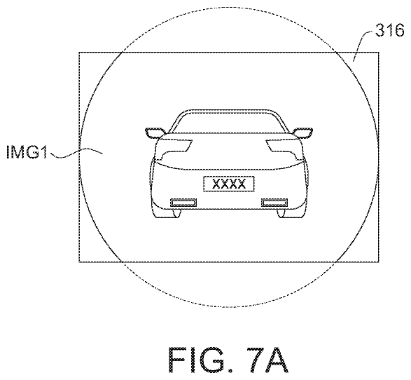

FIG. 4 is a schematic diagram of a first adjusted image SD1, a second image IMG2 and a first partial image ROI1 according to one embodiment of the present invention. FIG. 5 is a block diagram of an image recording device 20 according to another embodiment of the present invention. As shown in FIG. 1 and FIG. 5, the image recording device 20 is substantially similar to the image recording device 10, and the elements are substantially designated with the same reference numerals. The main difference between the image recording device 20 and the image recording device 10 is that the image recording device further includes a second image capturing module 104 electrically connected to the processor 106. The second image capturing module 104 includes a second lens 1041 and a second sensor 1042, the second image capturing module 104 may capture images in a second direction, and the second sensor 1042 may catch a light beam passing through the second lens 1041 and generate a second image IMG2.

Referring to FIGS. 3-5, the first image capturing module 102 and the second image capturing module 104 provide the first image IMG1 and the second image IMG2, respectively, to the processor 106. The processor 106 may select the first partial area R1 from the first image IMG1 and obtain the first partial image ROI1, and perform image adjustment on the first image IMG1 and generate the first adjusted image SD1 after image adjustment. In addition, the processor 106 may further stitch the first adjusted image SD1 and the second image IMG2 and generate an integrated image, and may store the first image IMG1, the second image IMG2, the first partial image ROI1, the first adjusted image SD1, and the integrated image IMG in accordance with the storage module 108. The first image capturing module 102 and the second image capturing module 104 may have the same field of view or different fields of view. Specifically, the processor 106 may calculate image data of overlapping areas of the first adjusted image SD1 and the second image IMG2 for stitching. The image data includes, but is not limited to, brightness, color saturation, RGB values, but the present invention is not limited thereto.

In one embodiment, before selecting the first partial area R1, the processor 106 may perform preliminary image processing on the first image IMG1 and the second image IMG2 respectively; in another embodiment, the integrated image IMG may be a horizontal 360-degree panoramic image.

In one embodiment, the second image IMG2 may have m₂×n₂ pixels. Herein, m₂ is the number of columns of the second image IMG2 arranged in the vertical direction, which may represent the length of the image; n₂ is the number of rows of the second image IMG2 arranged in the horizontal direction, which may represent the width of the image, and m₂ and n₂ are positive integers.

In one embodiment, the length of the second image IMG2 may not be equal to the length of the first adjusted image SD1, but the widths of both images are substantially equal, i.e., m₂≠a₁m₁, n₂=b₁n₁; in another embodiment, the length and width of the second image IMG2 are substantially equal to the length and width of the first adjusted image SD1, i.e., m₂=a₁m₁, n₂=b₁n₁; and in one specific embodiment, the number of pixels in the second image IMG2 is m₂×n₂=1920×960, but the present invention is not limited thereto.

In addition, referring to FIG. 5, in one embodiment, the processor 106 may also select a second partial area of the second image IMG2 and generate a second partial image, and generate a second adjusted image after image adjustment in accordance with image adjustment. The first image IMG1 has m₁×n₁ pixels, the second image IMG2 has m₂×n₂ pixels, the first partial image ROI1 has m₀×n₀ pixels, the second partial image has m′₀×n′₀ pixels, the first adjusted image SD1 has a₁m₁×b₁n₁, and the second adjusted image has a₂m₂×b₂n₂ pixels, wherein m₁, m₂, m₀, m′₀, n₁, n₂, n₀, and n′₀ are positive integers, a₁, a₂, b₁, and b₂ are positive numbers less than 1, and aims, a₂m₂, b₁n₁, and b₂n₂ are positive integers. In one specific embodiment, a₁, a₂, b₁ and b₂ may be between 0.4 and 0.6, respectively.

In one specific embodiment, the first image capturing module 102 and the second image capturing module 104 may capture images in opposite directions; that is, the first direction and the second direction may be substantially oriented by 180 degrees; in another specific embodiment, the first lens 1021 may be a fisheye lens, and the second lens 1041 may be a fisheye lens or a wide-angle lens; and in still another specific embodiment, the field of view of the first image capturing module 102 and the field of view of the second image capturing module 104 may overlap in the horizontal direction. For example, the fields of view of the first image capturing module 102 and the second image capturing module 104 in the horizontal direction are both 182 degrees, and thus the first image IMG1 and the second image IMG2 may have 2-degree overlaps respectively on both sides of the horizontal direction.

In one specific embodiment, the first image capturing module 102 and the second image capturing module 104 may be disposed in a back-to-back manner, and the image recording device 10 may be disposed on the rearview mirror, the front windshield, or on top of the dashboard in the vehicle, so that the first image capturing module 102 may capture images of the scene in front of the vehicle, and the second image capturing module 104 may capture images of the situation in the vehicle. In another specific embodiment, the first image capturing module 102 may be disposed on the rearview mirror, the front windshield, or on top of the dashboard, and the second image capturing module 104 may be disposed on the rear windshield to capture images of the scene at the back of the vehicle.

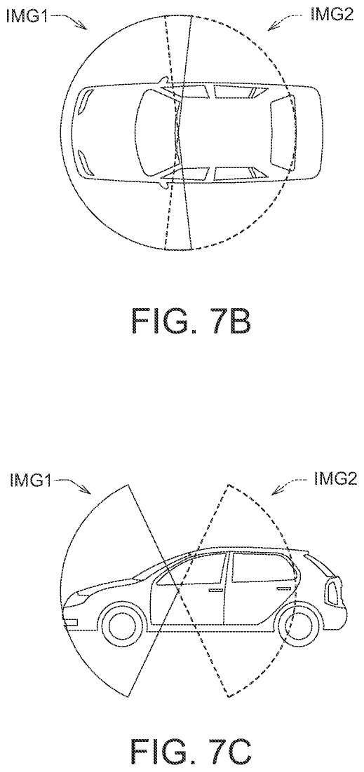

FIG. 6A is a schematic diagram of a first image IMG1 according to one embodiment of the present invention. FIG. 6B is a schematic diagram showing a field of view photographed in a horizontal direction according to one embodiment of the present invention. FIG. 6C is a schematic diagram showing a field of view photographed in a vertical direction according to one embodiment of the present invention.

As shown in FIG. 6A, if the first lens 1021 is a fisheye lens, a circular first image IMG1 may be obtained on the imaging surface 204, and the circular first image IMG1 may be fully imaged on the first sensor 1022. The areas 209, 210 are the black edges which do not contain data on the first sensor 1022, and in practice, the areas 209, 210 may be preliminarily image processed by removing the black edges, i.e., cropping or completely removing the black edges which do not contain data in the first image IMG1.

Referring to FIGS. 6A-6C, if the second lens 1041 is also a fisheye lens, the light beam passing through the second lens 1041 is also fully imaged on the second sensor 1042, and the sum of the fields of view of the first image capturing module 102 and the second image capturing module 104 is greater than 360 degrees, then the images in the horizontal direction and the vertical direction of the vehicle will overlap. Thus, the image recording device 20 may provide an integrated image IMG with a 360-degree panoramic view in both the horizontal and the vertical directions.

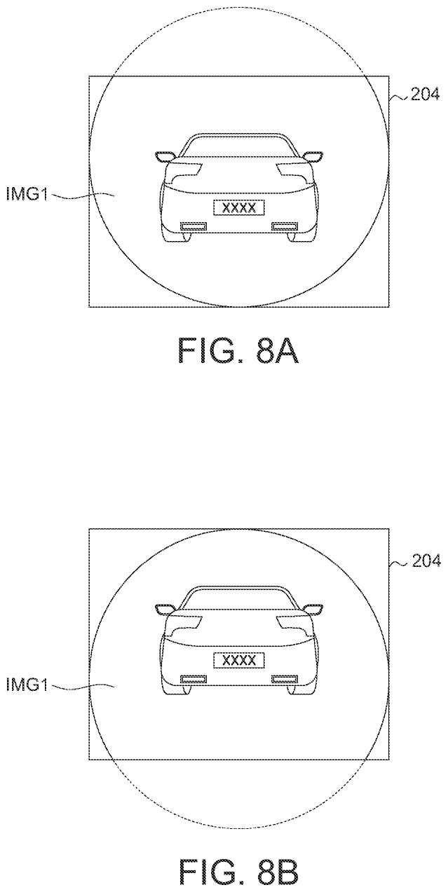

FIG. 7A is a schematic diagram of a first image according to another embodiment of the present invention. FIG. 7B is a schematic diagram showing a field of view photographed in a horizontal direction according to another embodiment of the present invention. FIG. 7C is a schematic diagram showing a field of view photographed in a vertical direction according to another embodiment of the present invention.

As shown in FIG. 7A, in another embodiment, a circular first image IMG1 passing through the first lens 1021 is imaged on the first sensor 1022, and the center of the first image IMG1 may substantially coincide with the center of the first sensor 1022. In practice, at this time, two edges of the first image IMG1 in initial size disposed along the horizontal direction may be substantially tangent to two perimeters of the first sensor 1022 disposed along the horizontal direction, while two portions of area along the vertical direction are outside of the first sensor 1022 and are not captured by the first sensor 1022, and the area 316 with black edge is smaller in size and the utilization rate of the first sensor 1022 is higher.

Referring to FIGS. 7A-7C, if two edges of the second image IMG2 disposed along the horizontal direction may also be substantially tangent to two perimeters of the second sensor 1042 disposed along the horizontal direction, two portions of area of the second image IMG2 in initial size along the vertical direction are outside of the second sensor 1042 and are not captured by the second sensor 1042, and the sum of the fields of view of the first image capturing module 102 and the second image capturing module 104 is greater than 360 degrees, then the images in the horizontal direction of the vehicle will overlap while the images in the vertical direction will not overlap. Thus, the image recording device 20 may provide an integrated image IMG with a 360-degree panoramic view in the horizontal direction and discontinuous panoramic view in the vertical direction.

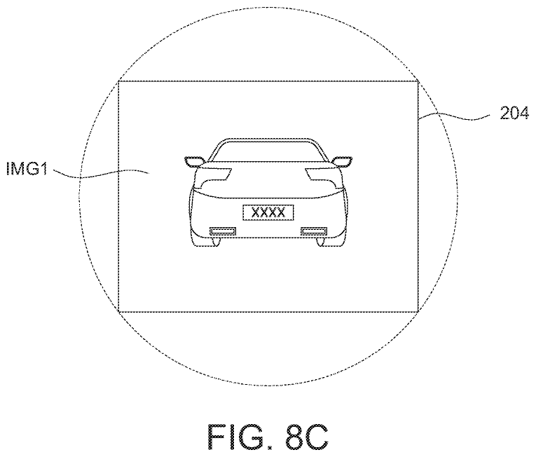

FIG. 8A is a schematic diagram of a first image according to still another embodiment of the present invention. FIG. 8B is a schematic diagram of a first image according to still another embodiment of the present invention. FIG. 8C is a schematic diagram of a first image according to further embodiment of the present invention.

Referring to FIG. 8A and FIG. 8B, in still another embodiment, two edges of the first image IMG1 in initial size disposed along the horizontal direction and one edge of the first image IMG1 in initial size disposed along the vertical direction may be substantially tangent to two perimeters of the first sensor 1022 disposed along the horizontal direction and one perimeter of the first sensor 1022 disposed along the vertical direction, and a portion of area of the first image IMG1 in initial size disposed along another vertical direction is outside of the first sensor 1022 and is not captured by the first sensor 1022; or, as shown in FIG. 8C, in further embodiment, the first image IMG1 in initial size may circumscribe the imaging surface 204 of the first sensor 1022 so that portions of area of the first image IMG1 in initial size along the horizontal direction and the vertical direction are all outside of the first sensor 1022.

In one embodiment, the first partial area R1 of the first image IMG1 may be of interest to the driver or information which is required to be checked, such as the license plate number of the vehicle in front of the driver. In practice, it usually appears within a sector ranged from about 100 to 150 degrees in front of the image recording device 10, 20, and thus the present invention may capture the image within this region in accordance with the processor 106, and may maintain the original resolution and avoid distortion and loss of information. Similarly, the processor 106 may also select the second partial area R2 from the second image IMG2 provided by the second image capturing module 104 and copy the second partial image for archiving.

In another embodiment, the processor 106 may determine the selected first partial area R1 based on one or more features in the first image IMG1. Specifically, the processor 106 may identify the lane lines from the first image IMG1, calculate the intersection at which the lane lines extend, and determine the selected first partial area by regarding the intersection as the center. Similarly, the processor 106 may determine the selected second partial area according to the intersection at which the lane lines extend in the second image IMG2.

The present invention provides an image recording device and an image processing method, a target object which is located at a certain distance from a lens may be recorded with sufficient resolution and easily recognized in an integrated image IMG in condition of limited hardware performance.

It will be apparent to those skilled in the art that various modifications and variations can be made to the disclosed embodiments. It is intended that the specification and examples be considered as exemplary only, with a true scope of the present invention being indicated by the following claims and their equivalents.

What is claimed is:

1. An image recording device comprising:
a first image capturing module comprising a first lens and a first sensor, the first sensor catching a light beam passing through the first lens and providing a first image;
a processor selecting a first partial area of the first image, copying image data of the first partial area and providing a first partial image, and adjusting the first image and generating a first adjusted image; and
a storage module storing the first image, the first partial image and the first adjusted image.

2. The image recording device according to claim 1, wherein the first partial area is selected fixedly from an image corresponding to a specific angle ranged from a horizontal direction in which the first image capturing module captures images to both sides expanded from the horizontal direction; or, the first partial area is selected based on an intersection at which two lane lines extend in the first image.

3. The image recording device according to claim 1, wherein the processor generates the first adjusted image by reducing pixels of the first image.

4. The image recording device according to claim 1, further comprising a second image capturing module capturing a second image, wherein the processor stitches the first adjusted image and the second image and generates an integrated image.

5. The image recording device according to claim 4, wherein the first image has m₁×n₁ pixels, the second image has m₂×n₂ pixels, the first partial image has m₀×n₀ pixels, the first adjusted image has a₁m₁×b₁n₁ pixels, m₁, m₂, m₀, n₁, n₂, n₀, aims and bins are positive integers, and a₁ and b₁ are positive numbers less than one.

6. An image recording device comprising:
a first image capturing module comprising a first sensor, the first sensor catching light beam and providing a first image;
a second image capturing module catching light beam and providing a second image; and
a processor generating a first partial image with the first image, and/or generating a second partial image with the second image, and stitching the first image and the second image to generate an integrated image.

7. The image recording device according to claim 6, wherein the processor reduces pixels of the first image and/or the second image before stitching the first image and the second image.

8. The image recording device according to claim 6, wherein the processor adjusts the first image and/or the second image before stitching the first image and the second image for a width of the first image being substantially the same with a width of the second image.

9. The image recording device according to claim 8, wherein the first image has m₁×n₁ pixels, the second image has m₂×n₂ pixels, the first partial image has m₀×n₀ pixels, the second partial image has m′₀×n′₀ pixels, the first image after being adjusted has a₁m₁×b₁n₁ pixels, the second image after being adjusted has a₂m₂×b₂n₂ pixels, m₁, m₂, m₀, m′₀, n₁, n₂, n₀, n′₀, aims, bins, a₂m₂ and b₂n₂ are positive integers, and a₁, a₂, b₁ and b₂ are positive numbers less than one.

10. The image recording device according to claim 9, further comprising a storage module storing at least one of the first image, the second image, the first partial image, the second partial image, the integrated image, the first adjusted image and the second adjusted image.

11. The image recording device according to claim 6, wherein the first image is fully imaged on the first sensor, or two edges of the first image disposed along a horizontal direction are substantially tangent to two perimeters of the first sensor disposed along the horizontal direction.

12. The image recording device according to claim 6, wherein the processor recognizes two lane lines from the first image/the second image, calculates an intersection at which the two lane lines extend, and determines the first partial image/the second partial image with the intersection.

13. The image recording device according to claim 6, wherein the processor calculates image data of an overlapping area of the first image and the second image, and stitches the first image and the second image to generate the integrated image with 360-degree panorama.

14. The image recording device according to claim 6, wherein the first image capturing module is a fisheye lens, and the second image capturing module is a fisheye lens or a wide-angle lens.

15. An image processing device comprising:
a first image capturing module capturing a first image; and
a processor selecting a first partial area of the first image, copying image data of the first partial area and providing a first partial image, and adjusting the first image and generating a first adjusted image.

16. The image recording device according to claim 15, further comprising a second image capturing module providing a second image, and the processor stitching the first adjusted image and the second image and generating an integrated image.

17. The image recording device according to claim 16, wherein the processor reduces pixels of the first image and/or the second image before stitching the first adjusted image and the second image and a width of the first adjusted image being substantially the same with a width of the second image.

18. The image recording device according to claim 16, wherein the first image has m₁×n₁ pixels, the second image has m₂×n₂ pixels, the first partial image has m₀×n₀ pixels, the first adjusted image has a₁m₁×b₁n₁ pixels, m₁, m₂, m₀, n₁, n₂, n₀, aims and bins are positive integers, and a₁ and b₁ are positive numbers less than one.

19. The image recording device according to claim 16, further comprising a storage module storing at least one of the first image, the second image, the first partial image, the first adjusted image and the integrated image.

20. The image recording device according to claim 15, wherein the first partial area is selected fixedly from an image corresponding to a specific angle ranged from a horizontal direction in which the first image capturing module captures images to both sides expanded from the horizontal direction; or, the first partial area is determined by lane lines in which an user drives a vehicle.
